(19) United States
(12) Patent Application Publication
(10) Pub. No.: US 2026/0044142 A1
(43) Pub. Date: Feb. 12, 2026

(54) GMM FOR ANOMALY DETECTION OF HARMONIC DRIVE

(71) Applicant: FANUC CORPORATION, Yamanashi (JP)

(72) Inventors: Yujiao Cheng, Sunnyvale, CA (US); Tetsuaki Kato, Fremont, CA (US)

(21) Appl. No.: 18/795,902

(22) Filed: Aug. 6, 2024

(51) Int. Cl. G05B 23/02

(52) U.S. Cl. CPC G05B 23/0221; G05B 23/027

(57) ABSTRACT

A method and system for anomaly detection from time-series input data. A Gaussian mixture model (GMM) learns distribution parameters in an offline learning stage using sample data. The data used for the offline learning, and for a subsequent online anomaly detection stage, is time-series data collected for multiple parameters of a machine operation, such as a robot performing a repetitive set of operations. The method includes aligning the data to and taking a difference from a known good reference data file, before providing the data to the GMM. In the online anomaly detection stage, the GMM computes a probability that each time-series data point fits the distribution, and a log summing computation is performed on each data file to determine the likelihood that the file contains anomaly data. The file log likelihood is compared to previous values and an alarm is issued when statistically variant from the historical data.

### BACKGROUND

### Field

The present disclosure relates generally to a method for anomaly detection in time-series data and, more particularly, to a method for anomaly detection which collects time-series data for multiple parameters of a machine operation, aligns the data to and takes a difference from a known good reference data file, and uses a Gaussian mixture model (GMM) along with a log summing computation to determine the likelihood that a time-series data file contains normal data.

### Discussion of the Related Art

Anomaly detection is a broad class of computational analysis where some type of input data sample is analyzed to determine whether the data sample represents a normal condition or an anomaly condition. The data sample may be an image of a part, in which case the analysis determines whether the part is normal or an anomaly, or the data sample may be time-series data from an operation, in which case the analysis determines whether the operating conditions are normal or an anomaly.

Industrial robots are used in many types of operations—including processing applications such as laser welding and painting, and material movement applications such as picking parts off of a conveyor and placing them in a secondary location such as a compartmented container. In many of these applications, the robots repeatedly perform similar motions, but these motions may not be exactly the same from one movement trajectory to the next.

Modern robots include sensory devices and data analysis algorithms which are employed to determine if and when a robot component has failed or is in a degraded condition. Oftentimes, however, these detection devices and software systems can only detect a problem after the problem has developed to a significant degree.

Furthermore, because many robots perform a variety of operations which may be similar but not exactly the same, it is not possible to simply evaluate parameter data and look for any small change in a value from one operation to the next. This is because fairly minor-looking changes in a tool center point trajectory or acceleration profile can have a large effect on joint loads and accelerations.

In view of the circumstances described above, improved methods are needed for anomaly detection from time-series input data where initial stages of performance degradation may be difficult to detect using existing techniques.

### SUMMARY

The following disclosure describes a method and system for anomaly detection from time-series input data. A Gaussian mixture model (GMM) learns distribution parameters in an offline learning stage where sample data is used for the learning. The data used for the offline learning, and for a subsequent online anomaly detection stage, is time-series data collected for multiple parameters of a machine operation, such as a robot performing a repetitive set of operations. The method includes aligning the data to and taking a difference from a known good reference data file, before providing the data to the GMM. In the online anomaly detection stage, the GMM computes a probability that each time-series data point fits the distribution, and then a log summing computation is performed on each complete time-series data file to determine the likelihood that the file contains normal data. The file log likelihood is compared to previous values and an alarm is issued when the file log likelihood is statistically variant from the historical data.

Additional features of the present disclosure will become apparent from the following description and appended claims, taken in conjunction with the accompanying drawings.

### BRIEF DESCRIPTION OF THE DRAWINGS

FIG. 1 is an illustration of an industrial robot performing a set of repetitive tasks, along with a representation of data collected during the robotic operations, as used in the techniques of the present disclosure;

FIG. 2 is a block diagram illustration of an anomaly detection system including an offline learning section where a Gaussian mixture model learns distribution parameters to fit sample data, and an online anomaly detection section which employs the Gaussian mixture model, according to embodiments of the present disclosure;

FIG. 3 is an illustrated flowchart diagram of a method for preprocessing time-series data files in preparation for anomaly detection using a Gaussian mixture model as depicted in FIG. 2, according to an embodiment of the present disclosure;

FIG. 4 is an illustrated flowchart diagram of a method for determining a likelihood value for a time-series data file using the Gaussian mixture model of FIG. 2, where the likelihood value indicates whether the data file is nominal or anomalous, according to an embodiment of the present disclosure; and

FIG. 5 is a flowchart diagram of a method for anomaly detection in time-series data, including using a Gaussian mixture model applied to preprocessed data along with subsequent analytic computations, according to embodiments of the present disclosure.

### DETAILED DESCRIPTION OF THE EMBODIMENTS

The following discussion of the embodiments of the disclosure directed to a method for anomaly detection in time-series data using a Gaussian mixture model is merely exemplary in nature, and is in no way intended to limit the disclosed techniques or their applications or uses.

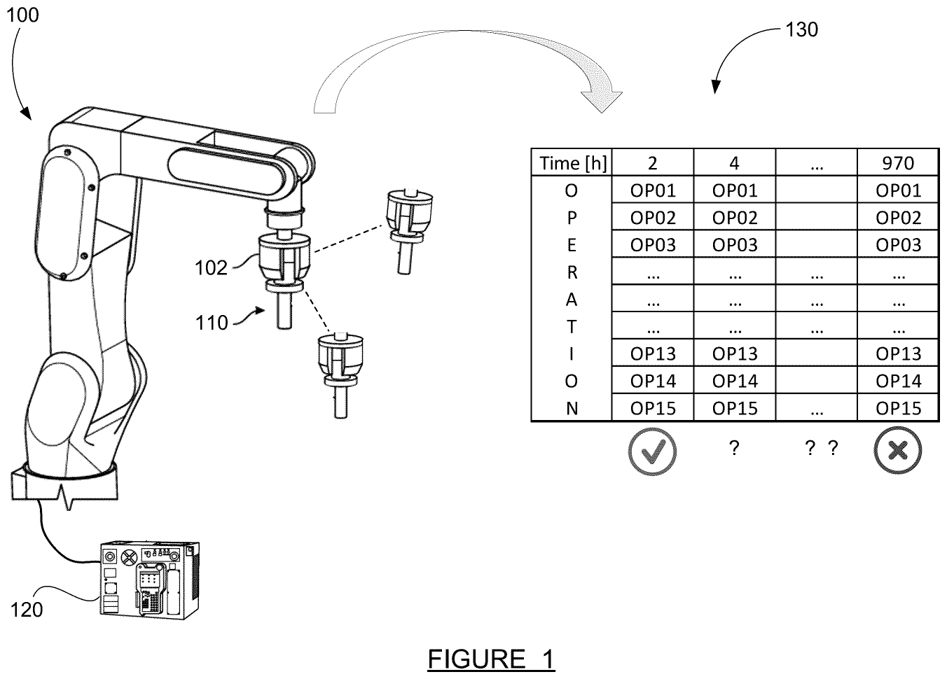

FIG. 1 is an illustration of an industrial robot performing a set of repetitive tasks, along with a representation of data collected during the robotic operations, as used in the techniques of the present disclosure. A robot 100 is a typical multi-axis articulated robot as commonly used in industrial applications. The robot 100 has a set of arm links interconnected by rotational joints with joint motors—such as servo motors with harmonic drive gearing. The operation depicted in FIG. 1 is a part movement or placement application, where the robot 100 is fitted with a gripper 102 which grasps a workpiece 110 and moves the workpiece 110 from one location to another. The workpiece 110 is shown in other locations proximal the robot tool center, simply to illustrate the workpiece movement to multiple locations. A controller 120 controls motion of the robot 100 in a known manner, including issuing joint motion commands designed to move the tool center point (gripper 102) through a prescribed motion profile.

In a scenario discussed throughout the present disclosure, the robot 100 repetitively performs a set of similar operations. These operations could include moving the workpiece 110 from a fixed starting location to various compartments of a container for shipping, where each trajectory is slightly different depending on the spatial location of the compartment into which the workpiece is placed. Another example would be where the spatial trajectory of all of the operations is exactly the same, but the velocity and acceleration profile is different from one operation to the next—such as if the time allotted to complete each operation is different. In either of these examples, anomaly detection in the time-series data is challenging because although the trajectories are all similar, the exact values of joint torques and motions are not the same from one operation to the next.

In addition to controlling the robot 100, the controller 120 also collects data during robotic operations. A table 130 depicts the data collection framework for the scenario described above. The robot 100 repetitively performs a set of 15 operations, labeled as OP01 through OP15. A time-series data file is recorded for each of the 15 operations once in every two-hour time window. It is known that the robot is in good working order at the first data collection window (i.e., t=2 hours); for example, the robot 100 may have just been placed in service when new or immediately after a service overhaul. The known good status of the robot 100 is indicated by the checkmark at the bottom of the first column of the table 130. Many hundreds of working hours later (e.g., at t=970 hours), a robot sensor indicates a malfunction in a component—such as a harmonic drive component in a high-load joint. This detected malfunction triggers a shutdown of the robot 100 for repairs. The detected component failure is indicated by the circled x at the bottom of the last column of the table 130.

Analysis of robotic components after a malfunction indicate that the component which malfunctioned often undergoes a period of degradation before the ultimate malfunction. Unfortunately, however, this period of degradation is difficult or impossible to detect using traditional robotic performance sensors and even existing anomaly detection methodologies. The techniques of the present disclosure have been developed to provide advanced detection of anomalies in earlier stages of the onset of degradation, so that repairs may be made before other components in the robot are damaged or the performance of the robotic operations is adversely affected.

FIG. 1 depicts data collection for a multi-axis industrial robot, examples of which are discussed throughout the present disclosure. However, the techniques of the present disclosure are applicable to time-series data from any type of machine—not just industrial robots.

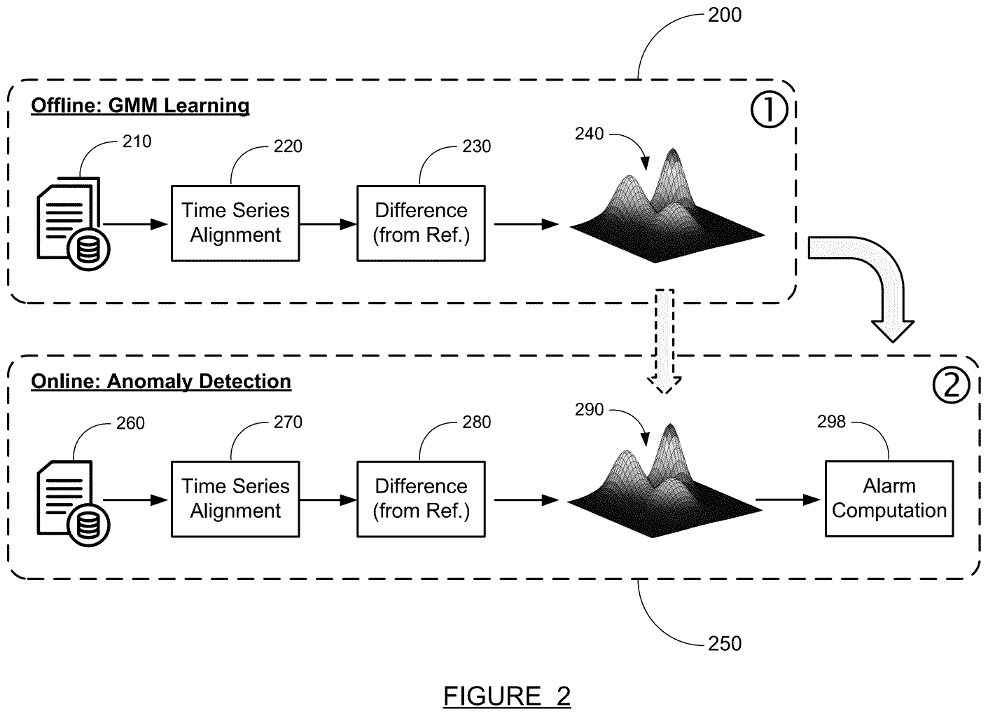

FIG. 2 is a block diagram illustration of an anomaly detection system including an offline learning section where a Gaussian mixture model (GMM) learns distribution parameters to fit sample data, and an online anomaly detection section which employs the Gaussian mixture model, according to embodiments of the present disclosure. An offline learning block 200 is used for learning GMM distribution parameters based on sample time-series data which is known to represent good performance by the robot (e.g., the robot 100 depicted in FIG. 1).

Input data files 210 each contain time-series data for robot parameters as initially discussed above. In one non-limiting example, each of the data files 210 includes data collected for a duration of 2.0 seconds at 250 Hz (thus, each file contains 500 data points). In this same example, data is collected for three different robot parameters during each two-second data collection event, and the two-second data collection event is applied to each of the 15 operations (OP01-OP15) once per two-hour period. More details of the data file contents and the specific robot parameters is provided later.

For each of the input data files 210, a time-series alignment to a reference data file is performed at box 220. The time-series alignment combines or adds sequential data points as necessary to absorb any temporal misalignment of data points between a current input data file and a stored reference file. In a preferred embodiment, the stored reference file is recorded at the beginning of the robot's service window—such as at t=2 hours in the table 130 of FIG. 1—when the robot is known to be in good working order with all components in new or like-new condition. A reference file is recorded for each of the parameters included in the input data files 210. For example, if three different parameters are measured and provided in the data files 210 (such as torque and position related parameters at a joint), then a reference file is recorded and stored for each of the three parameters.

At box 230, a difference operation is performed between each of the input data files 210 and the corresponding reference data file. After the time-series alignment, the differencing allows the comparative point-to-point difference to be used for GMM purposes rather than the magnitude of the measured data, where the difference provides greater sensitivity in anomaly detection. The time-series alignment step and the differencing step are discussed further with respect to the next figure.

A GMM 240 is provided and learns its Gaussian distribution parameters based on the learning sample data contained in the data files 210. The GMM 240 is configured with a defined number of Gaussian distributions (e.g., three, or five, or ten), and in the offline learning block 200 the GMM 240 learns the mean and standard deviation of each of the Gaussian distributions which best fits the learning sample data in the input data files 210.

The exact details of the input data files 210 used in the offline learning block 200 may be defined as suitable for a particular implementation. For example, the first 100 data files (i.e., the data files from the first 100 2-hour time windows) may be assumed to be good, and used for GMM learning. Also, not all of the 15 operations need be used for GMM learning; for example, only eight or ten of the 15 operations may be used for GMM learning, and the resulting GMM Gaussian distribution parameters still accurately reflect parameter data from all 15 operations by the robot.

After the offline learning block 200, an online anomaly detection block 250 is employed. Operational data files 260 are provided, typically one at a time, which contain time-series data for the three parameters each of the 15 operations (OP01-OP15). The operational data files 260 have the same format as the input data files 210 discussed above, where the input data files 210 are from the initial operations of the robot after placed in service (e.g., the first 100 time-series files for each parameter, believed to represent good operating conditions), and the operational data files 260 are from ongoing operations of the robot after the initial GMM learning. The goal of the presently disclosed techniques is to detect anomalies in the operational data files 260.

Time-series alignment to the reference data file is performed at box 270, and differencing from the reference data file is performed at box 280. The time-series alignment and differencing calculations in the online anomaly detection block 250 are the same as those in the offline GMM learning block 200, and are discussed further below.

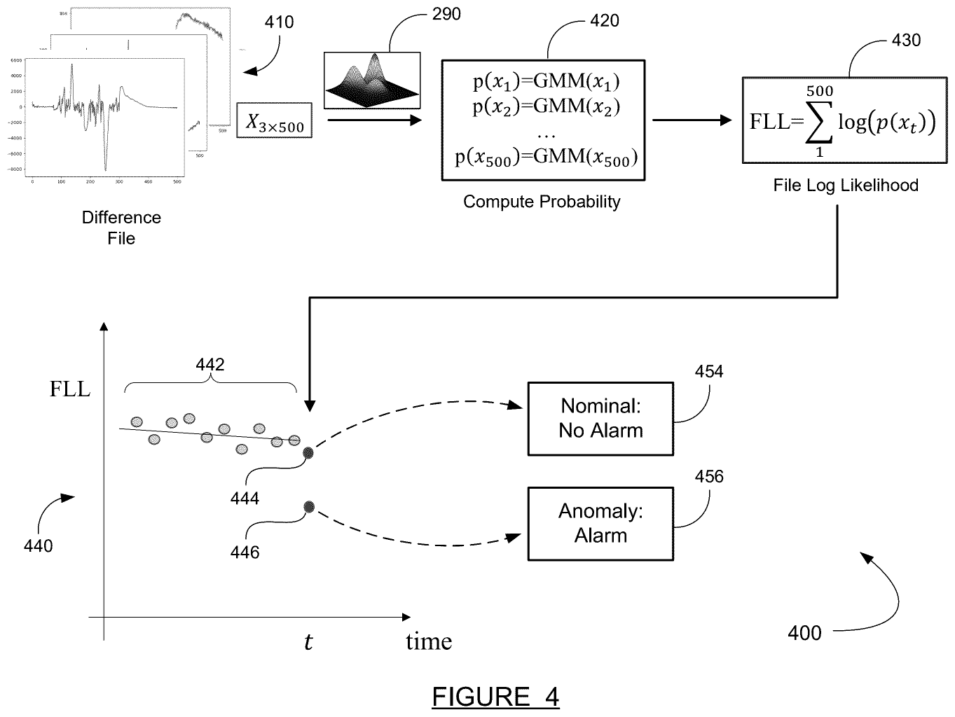

The GMM 240, after learning its Gaussian distribution parameters in the offline learning block 200, is identified as a GMM 290 and is used in the online anomaly detection block 250. For each data point in each of the operational data files 260, the GMM 290 computes a probability that the data point fits the distribution data contained in the GMM 290. In an alarm computation box 298, a computation is then performed for each of the operational data files 260, where the log of the probability value for each of the points (e.g., 500 points) in the data file is summed, and the resulting sum (known as a file log likelihood) is compared to previous data points. The GMM probability calculation and the file log likelihood computation and analysis are discussed in detail below with respect to FIG. 4.

In the system depicted in FIG. 2, a single GMM 240 is provided and learns the Gaussian distribution parameters in the offline learning block 200, and the single GMM 290 after learning is used in the online anomaly detection block 250. The GMM 290 embodies the statistical distribution of all of the measured operating parameters and all of the different operations (e.g., 15). In one non-limiting embodiment, three different robot joint parameters are measured for each of the 15 operations at each of the measurement windows. The three joint parameters were selected based on their ability to identify variation from one operation to the next, and their corresponding ability to predict anomalies when analyzed using the GMM. The three parameters in this example implementation include; joint torque command (the controller-commanded torque to a particular robot joint, such as the first horizontal-axis joint in the robot 100 of FIG. 1), disturbance torque (the difference between the commanded torque and the total actual torque), and deviation (difference between the desired position and the actual position). In the example embodiment, all three parameters are recorded for the same robot joint. In other implementations, data from different joints, and/or different parameters may be recorded.

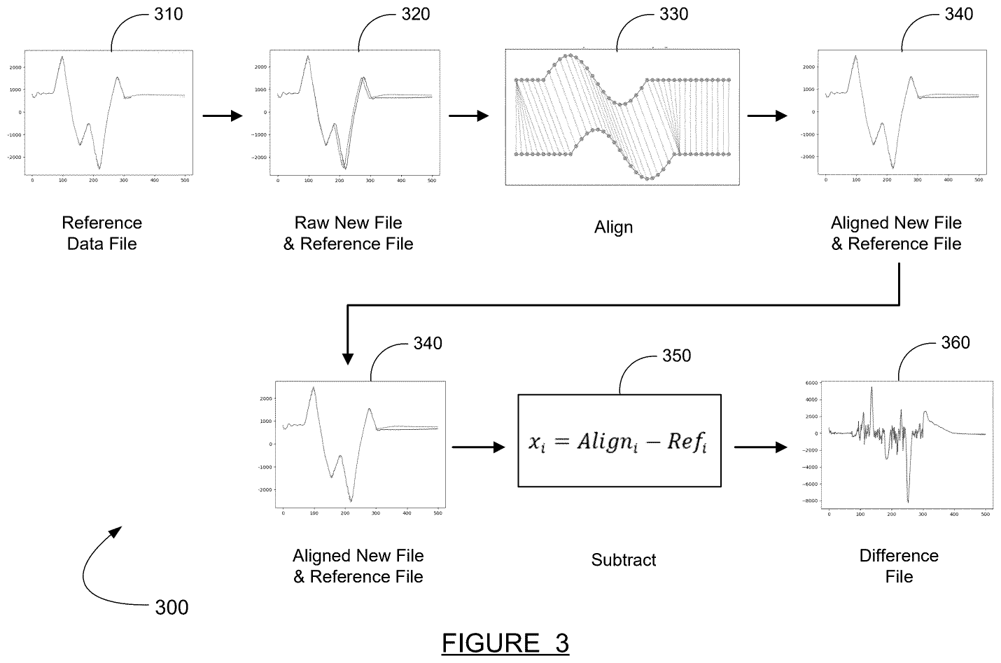

FIG. 3 is an illustrated flowchart diagram 300 of a method for preprocessing time-series data files in preparation for anomaly detection using a Gaussian mixture model as depicted in FIG. 2, according to an embodiment of the present disclosure. FIG. 3 depicts the time-series alignment steps (the boxes 220 and 270) and the differencing steps (the boxes 230 and 280) of FIG. 2.

A reference time-series data file is first provided, as shown in a graph 310 and as discussed above. The reference file in the graph 310 includes time-series data for the parameters for an operation (e.g., OP01) from very early in the robot's lifecycle when the robot is known to be performing normally and the parameters reflect normal operations. FIG. 3 depicts the method steps and data flow for one parameter (e.g., torque command), for one robotic operation. It is to be understood that the reference file also includes data for each other parameter (e.g., the other two, if three parameters are measured), and reference files are provided for many if not all of the other operations (e.g., OP02-OP10). In a preferred embodiment, the reference data file contains data for all parameters and for all time steps for one operation. That is, the reference data file may have dimensions of 3×500. Again, only one parameter is shown in the graphs of FIG. 3, for visual clarity reasons.

A graph 320 plots a new time-series data file along with the reference data file, where minor differences can be seen. The new time-series data file shown in the graph 320 is for the same joint parameter (e.g., torque command) and the same operation (e.g., OP01) as the reference data file shown in the graph 310. Once again, each new time-series data file has the same dimensions (e.g., 3×500) as the reference data file described above. The new time-series data file is one of the input data files 210 used for training in the offline GMM learning block 200, and the new time-series data file is one of the operational data files 260 in the online anomaly detection block 250.

At box 330, a time-series alignment operation is performed to temporally align the new time-series data file with the reference data file. For example, if the new time-series data file is shifted by one or two data points (earlier or later) in comparison to the reference data file, the alignment operation will adjust the new file so that it is synchronized with the reference data file, which avoids the appearance of a difference in measured values at every point. Similarly, multiple points may be combined or replicated elsewhere in the time-series data to maintain optimal synchronization of the new data file with the reference data file. Time-series data alignment techniques are known in the art—and at least one such technique, such as dynamic time warping, is used in the alignment at the box 330.

A graph 340 plots the aligned new data file (the output of the box 330) along with the reference file. In comparing the graph 340 to the graph 320, it can be seen that the horizontal (temporal) offset between the two traces in the high-slope middle portion of the graphs has been eliminated in the graph 340. In contrast, the vertical offset in the horizontal end portion of the graphs still remains in the graph 340. These differences illustrate the effect and the effectiveness of the time-series alignment operation of the box 330.

The graph 340 of the aligned new data file along with the reference file is shown again for visualization purposes at the bottom left portion of FIG. 3. At box 350, a subtraction or differencing operation is performed between the aligned new data file and the reference data file. That is, for each of the points i in each data file (e.g., 500 points), the value of the reference data file is subtracted from the value of the aligned new data file. Thus, if the difference file is designated as x, then the values in the difference file are determined by:

$${x}_{i} = {Align}_{i} - {Ref}_{i} \qquad ( 1 )$$

Where Alignᵢ is a point i in the aligned new data file, and Refᵢ is a point i in the reference data file. The subtraction operation at the box 350, like the alignment operation at the box 330, is performed for each of the three parameters contained in the new time-series data file relative to its corresponding parameter data in the reference data file.

A graph 360 plots the difference file x for the 2-second data collection event (e.g., 500 data points) for the selected parameter. It can be seen that difference data in the graph 360 bears no resemblance to the new data file, the reference file or the aligned data file; this is to be expected. The X and Y axis labels are not meant to be discernable in the graphs of FIG. 3—but it should be understood that the range of Y values in the difference data graph 360 is much smaller than the range of Y values in the other graphs of raw data.

Referring again to FIG. 2, in the offline learning block 200, after the preprocessing steps of FIG. 3, the difference data files are used for GMM learning. The difference data files include all of the three robot joint parameters, and are provided for many if not all (e.g., 10 out of 15) of the different robotic operations; all of these files are provided for many periods of robot operation early in the lifecycle of the robot (e.g., the data files from the first 100 of the 2-hour windows, or the first 150, etc.). Using these data files, GMM learning is accomplished using a suitable learning technique. In one non-limiting embodiment, an expectation-maximization (EM) algorithm is used. An expectation-maximization (EM) algorithm is an iterative method to find local maximum likelihood or maximum a posteriori (MAP) estimates of parameters in statistical models, such as a Gaussian mixture model. Thus, the offline learning block 200 uses sample data from normal robotic operations to produce the GMM 240 (then 290) which has learned the Gaussian distribution parameters associated with the time-series data describing the robot joint parameters and the various robotic operations.

The preprocessing steps depicted in FIG. 3 (time-series alignment and differencing with a reference data file) are also performed in the online anomaly detection block 250, as discussed earlier. In the online anomaly detection block 250, the difference time-series data files are provided to the GMM 290, which computes probabilities as discussed below.

FIG. 4 is an illustrated flowchart diagram 400 of a method for determining a likelihood value for a time-series data file using the Gaussian mixture model of FIG. 2, where the likelihood value indicates whether the data file is nominal or anomalous, according to an embodiment of the present disclosure. FIG. 4 illustrates the details of the computations on the right-hand side of the online anomaly detection block 250 of FIG. 2.

The three-parameter difference file, prepared as described above with respect to FIG. 3, is shown at 410. In the example being discussed here, the difference file has dimensions (3×500); that is, it contains data points for each of the three robot joint parameters at all of the 500 time steps (e.g., 2.0 seconds at 250 Hz). The GMM 290 is shown to the right of the difference file. The GMM 290 is the output of the offline GMM learning block 200 of FIG. 2, as discussed earlier.

At box 420, the GMM 290 is used to compute a probability that each of the 500 data points (each including data for the three parameters) fits the Gaussian statistical distributions of the GMM 290. This is shown in the box 420 as p(xₜ)=GMM(xₜ), where p(xₜ) is the probability value for point x, which is returned from the GMM 290 applied to the point x, (GMM(xₜ)). In a preferred embodiment, the probability has a value in a range from zero to one. For example, if the first point (x₁) in the difference file is a very good fit to the GMM 290, then p(x₁) will have a value near 1.0. Conversely, if the 250th point (x₂₅₀) in the difference file is not a very good fit to the GMM 290, then p(x₂₅₀) will have a value significantly less than 1.0, such as 0.5. The output of the box 420 is a probability value for each of the 500 time steps in the difference file (where the difference file represents a new time-series data file as shown in FIG. 3).

At box 430, a file log likelihood (FLL) value is computed for the difference file. The file log likelihood is a single numerical value which characterizes how well the current new time-series data file (represented by the difference file) fits the GMM 290. In a preferred but non-limiting embodiment, the file log likelihood is computed by:

$$FLL = {\sum }_{1}^{500} log ( p ( {x}_{t} ) ) \qquad ( 2 )$$

Where p(xₜ) is the GMM probability for each time-series point as described above. Thus, the file log likelihood is the sum of the log of the probabilities for all 500 data points. For example, if all 500 data points are a perfect fit to the GMM 290, then all 500 probabilities will be equal to 1.0, and the log of each of the 500 probabilities will be equal to 0.0. Thus, in this fictitious example, the value of FLL will be 0.0. Conversely, if the data file has several points which are not a good fit to the GMM 290, then those data points will have probabilities significantly less than 1.0, and the log of those probabilities will be negative. Thus, in this example, the value of FLL will be a negative number.

The final step in the disclosed technique is to evaluate the FLL value and determine whether the data file is nominal or anomalous. This was the step shown in the box 298 of FIG. 2. A graph 440 on FIG. 4 is a plot of FLL values over time. Shown at 442 are a number of historical FLL values which were computed for previous time-series data files for various robotic operations. It can be observed that the historical FLL values all fall within a small range of values, and that they have a slightly downward trend over time. The downward trend may be an indication that, as the robot accumulates more hours of operation, certain parasitic effects such as friction and looseness may be increasing slightly. A trend line may be drawn through the historical FLL values as shown, and the standard deviation of the values relative to the trend line may be computed in a known manner.

A new FLL value 444 is plotted just to the right of the historical FLL values. The new FLL value 444 has just been computed, at the box 430, for a new time-series data file. The new FLL value 444 is evaluated relative to the historical FLL values in order to determine whether it represents nominal or anomalous performance. In one non-limiting embodiment, if the new FLL value 444 is within three standard deviations of the trend line of the historical FLL values, then the new FLL value 444 is determined to represent nominal performance, and no alarm is raised.

A later FLL value 446 is plotted below the new FLL value 444. The later FLL value 446 is computed, at the box 430, for a time-series data file after the robot has logged many more hours of operation. The later FLL value 446, like all FLL values, is evaluated relative to the historical FLL values in order to determine whether it represents nominal or anomalous performance. In the computational embodiment described above, the later FLL value 446 is found to be more than three standard deviations from the trend line of the historical FLL values; thus, the later FLL value 446 is determined to represent anomalous performance, and an alarm is issued.

The exact formula used for computation of the FLL, and the criteria for evaluating each new FLL value, may of course be modified to suit any particular application. In addition, the configuration of the GMM (240/290) may be adjusted to meet application requirements. Specifically, the number of Gaussian distributions to include in the GMM is a configuration parameter which may be selected. In evaluations of the disclosed techniques for anomaly detection in robotic joint data, results with a fairly small number of Gaussian distributions (3) were found to be as good as results with a larger number (10) of distributions.

The steps depicted in FIGS. 3 and 4 are performed for each time-series data file during online anomaly detection. That is, each time the three parameters are recorded for one of the operations, the resulting new time-series data file is preprocessed (FIG. 3) and then analyzed by computing the GMM probabilities and computing and evaluating the file log likelihood (FIG. 4). Thus, the disclosed techniques provide real-time anomaly detection monitoring of robotic operations, to look for signs of performance degradation.

Experimental evaluations have shown that the disclosed techniques are very effective for anomaly detection in robotic joint data. First, the GMM was trained using data from 10 of the 15 operations, and for the first 150 time periods in the robot's operation lifecycle. This GMM was then used to evaluate the robot's performance for the remaining time periods (e.g., 151-484) for the same 10 operations, and the performance was found to be very good. Specifically, the number of alarms suddenly jumped for files beginning at about time period number 450, which was almost three days before the robot detected a component malfunction and issued its own alarm using conventional techniques. This advance warning of component deterioration in the robot, provided by the GMM-based anomaly detection techniques of the present disclosure, offers significant opportunity to avoid costly and time-consuming damage to the robot and other negative consequences of component breakage or malfunction.

The GMM trained as discussed above (on 10 of the 15 operations) was then used to evaluate robot performance for the other five operations, for all 484 time periods. Again, the GMM-based anomaly detection model saw a jump in the number of alarms at a time over 2.5 days prior to the robot detecting a component malfunction using its own monitoring techniques.

Finally, the GMM trained as discussed above was used to evaluate performance of a different robot (of the same model as the training data robot) for all of the operations, for all 484 time periods. Again, the GMM-based anomaly detection model saw a jump in the number of alarms at a time well prior (almost two days prior) to the robot detecting a component malfunction using its own monitoring techniques.

The results summarized above indicate that the disclosed GMM-based anomaly detection techniques may be effectively employed to provide early warning of component or performance deterioration in robotic operations, including performing GMM learning using sample data from one robot and using the trained GMM in online anomaly detection on other robots of the same model and performing the same set of operations.

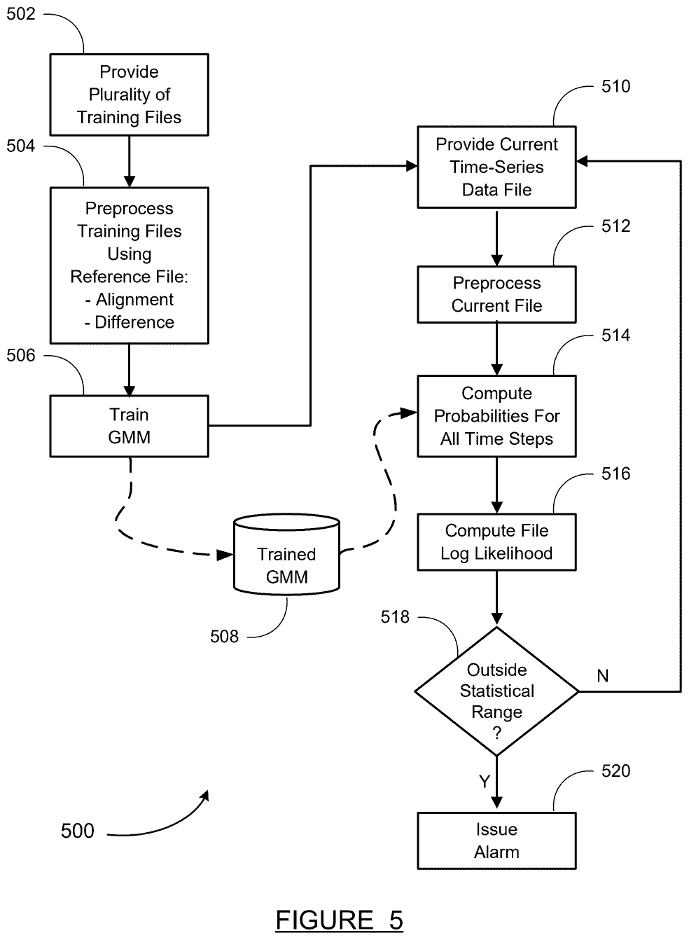

FIG. 5 is a flowchart diagram 500 of a method for anomaly detection in time-series data, including using a Gaussian mixture model applied to preprocessed data along with subsequent analytic computations, according to embodiments of the present disclosure. At box 502, a plurality of training files are provided, each containing time-series data for one or more parameters collected during one of a plurality of operations by a machine. In the main example discussed at length above, the training files each include 500 time steps of data for three different robot joint parameters, and the training files covered 10-15 different robotic operations over 100 or more measurement windows.

At box 504, the training files are preprocessed, including performing a time-series alignment of each of the training files to a reference file and computing a difference between each of the training files and the reference file. The preprocessing results in a training difference file for each of the plurality of training files. This preprocessing activity was shown in FIG. 3 and discussed in detail above. It is noted that in some applications, the time-series alignment operation may not be necessary, if the data collection system and the machining operation itself are inclined to provide well-aligned data. Furthermore, some applications may use the raw parameter data rather than the difference from a reference file, again depending on the nature of the parameter data. If the difference operation is not performed, then the mention of difference files in the remaining discussion of FIG. 5 should be interpreted to mean the data file itself (whether a training file or a current file for online anomaly detection).

At box 506, GMM learning or training is performed, using the training difference files, to learn a mean and standard deviation for each of a predefined number of Gaussian distributions in the GMM. This was depicted in the offline GMM learning block 200 of FIG. 2 and discussed earlier. The trained GMM 240 from the learning block 200 is stored as a trained GMM 508 and used as the GMM 290 in subsequent online anomaly detection analysis.

At box 510, in the online anomaly detection block 250, a current file is provided containing time-series data for the one or more parameters collected during one of the operations by the machine. The current data file includes time-series data for the same parameters (e.g., the three robot joint parameters), for any one of the operations (e.g., one of the 15 robotic operations). The current data file is collected for measurement windows after the collection of the training data files (e.g., after the first 100 or 150 2-hour measurement windows). The right-hand side of the flowchart diagram 500 depicts the steps for one “current file”. These steps are of course repeated for many new “current files” as the robot continues to perform the operations over time, until eventually the method results in alarms. At that point, the robot may be taken offline or out of service in order to perform further diagnostics or servicing.

At box 512, the current file is preprocessed, including performing a time-series alignment of the current file to the reference file and computing a difference between the current file and the reference file, resulting in a current difference file. The alignment and differencing at the box 512 are the same as in the box 504, except now being applied to the current file during online anomaly detection. As mentioned above, the preprocessing may be skipped in some applications, or only the alignment or the differencing operation may be included. The usage of none, one or both of the preprocessing steps is a matter of application configuration.

At box 514, a probability is computed for each time step in the current difference file, where the probability is a likelihood that the time step fits the Gaussian distributions in the trained GMM 508. In one embodiment, the probability ranges from a value of zero (complete mismatch to the GMM) to a value of one (perfect fit to the GMM). At box 516, a file log likelihood is computed for the current difference file from the probabilities for all of the time steps. In a preferred embodiment, the FLL is computed using a log sum calculation, in particular the calculation contained in Equation (2).

At decision diamond 518, it is determined whether the FLL for the current file falls within a predefined statistical range of the FLL for previous time-series data files. In one embodiment, the statistical range is within three standard deviations of a mean or trend line. When the file log likelihood for the current difference file is not within the predefined statistical variance range of previous files, an alarm is issued at box 520. It is to be understood that the “alarm” may be any type of alert, warning, notification, etc., as deemed suitable for a particular application. Furthermore, the occurrence of alarms for multiple files in succession may trigger an escalation in alert level. The alarms and alerts may include electronic communications, audible and/or visual alerts, and potentially a controlled shutdown of the robot. Again, these are all implementation configuration matters which may be selected as suitable for a particular application.

When the file log likelihood for the current file is within the predefined statistical variance range of previous files, then the current file is deemed to be normal operation—not an anomaly. In this case, the process returns to the box 510 to provide a new current data file—such as for a different operation within the current measurement window, or to wait for a next measurement window.

Throughout the preceding discussion, various computers are described and implied. It is to be understood that the software applications and modules of these computers are executed on one or more computing devices having a processor and a memory module. In particular, this includes computer(s) with processor(s) configured with algorithms performing the functions of the blocks in FIGS. 2-5. These computational algorithm may run on the robot controller 120 itself (or any machine controller for other types of machines), or on a separate computer which is in communication with the controller and receives the operational parameter time-series data.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A computer-implemented method for anomaly detection in time-series data from a machine, said method comprising:
providing a plurality of training files, each containing time-series data for one or more parameters collected during one of a plurality of operations by the machine;
training a Gaussian mixture model (GMM) having a predefined number of Gaussian distributions to learn a mean and a standard deviation for each of the distributions, using the training files;
providing a current file containing time-series data for the one or more parameters collected during one of the operations by the machine;
computing a probability for each time step in the current file, where the probability is a likelihood that the time step fits the Gaussian distributions in the GMM after training;
computing a file log likelihood (FLL) for the current file from the probabilities for all of the time steps, including using a log-sum calculation; and
issuing an alert when the FLL has a value outside a predefined statistical variance range of FLL values for previous files.

2. The method according to claim 1 wherein the operations are performed by an industrial robot and include moving a tool center point along a plurality of different spatial paths, and moving the tool center point along a prescribed spatial path with different velocity profiles.

3. The method according to claim 2 wherein the one or more parameters include combinations of actual and commanded positions and torques at one or more joints in the robot.

4. The method according to claim 1 further comprising preprocessing the training files before training the GMM and preprocessing the current file before computing the probabilities, where preprocessing includes performing a time-series alignment of each of the files to a reference file and computing a difference between each of the files and the reference file.

5. The method according to claim 4 wherein performing a time-series alignment includes using a dynamic time warping algorithm to temporally align points in each of the files to points in the reference file.

6. The method according to claim 4 wherein computing a difference includes computing a difference between points in each of the files to corresponding points in the reference file, and computing a difference results in a difference file which is used in training the GMM and computing the probabilities.

7. The method according to claim 4 wherein the reference file contains the time-series data for the parameters collected during one of the operations by the machine performed before the training files were recorded.

8. The method according to claim 1 wherein training the GMM includes using an expectation-maximization algorithm to cause the GMM to iteratively learn the mean and the standard deviation for each of the distributions until a learning convergence criteria is met.

9. The method according to claim 1 wherein computing a FLL for the current file includes taking a log of the probability for each of the time steps in the current file and calculating a summation of the log of the probabilities for all of the time steps.

10. The method according to claim 1 wherein the predefined statistical variance range is within three standard deviations of a mean or trend line of the FLL values for previous files.

11. A computer-implemented method for anomaly detection in time-series data from an industrial robot, said method comprising:
providing a plurality of training files, each containing time-series data for one or more parameters collected during one of a plurality of operations by the robot, where the parameters include combinations of commanded and actual joint torques and positions;
preprocessing the training files, including performing a time-series alignment of each of the training files with a reference file to produce an aligned file, and computing a difference between each of the aligned files and the reference file to produce a difference file;
training a Gaussian mixture model (GMM) having a predefined number of Gaussian distributions to learn a mean and a standard deviation for each of the distributions, using the difference files;
providing a current file containing time-series data for the one or more parameters collected during one of the operations by the robot;
preprocessing the current file, including performing a time-series alignment of the current file with the reference file to produce a current aligned file, and computing a difference between the current aligned file and the reference file to produce a current difference file;
computing a probability for each time step in the current difference file, where the probability is a likelihood that the time step fits the Gaussian distributions in the GMM after training;
computing a file log likelihood (FLL) for the current difference file from the probabilities for all of the time steps using a log-sum calculation; and
issuing an alert when the FLL has a value outside a predefined statistical variance range of FLL values for previous files.

12. A time-series anomaly detection system, said system comprising:
a computer having a processor and memory configured to perform steps including;
training a Gaussian mixture model (GMM) having a predefined number of Gaussian distributions to learn a mean and a standard deviation for each of the distributions, using a plurality of training files, each of the training files containing time-series data for one or more parameters collected during one of a plurality of operations by the machine;
computing a probability for each time step in a current file, the current file containing time-series data for the one or more parameters collected during one of the operations by the machine, where the probability is a likelihood that the time step fits the Gaussian distributions in the GMM after training;
computing a file log likelihood (FLL) for the current file from the probabilities for all of the time steps, including using a log-sum calculation; and
issuing an alert when the FLL has a value outside a predefined statistical variance range of FLL values for previous files.

13. The system according to claim 12 further comprising preprocessing the training files before training the GMM and preprocessing the current file before computing the probabilities, where preprocessing includes performing a time-series alignment of each of the files to a reference file and computing a difference between each of the files and the reference file.

14. The system according to claim 13 wherein performing a time-series alignment includes using a dynamic time warping algorithm to temporally align points in each of the files to points in the reference file.

15. The system according to claim 13 wherein computing a difference includes computing a difference between points in each of the files to corresponding points in the reference file, and computing a difference results in a difference file which is used in training the GMM and computing the probabilities.

16. The system according to claim 13 wherein the reference file contains the time-series data for the parameters collected during one of the operations by the machine performed before the training files were recorded.

17. The system according to claim 12 wherein training the GMM includes using an expectation-maximization algorithm to cause the GMM to iteratively learn the mean and the standard deviation for each of the distributions until a learning convergence criteria is met.

18. The system according to claim 12 wherein computing a FLL for the current file includes taking a log of the probability for each of the time steps in the current file and calculating a summation of the log of the probabilities for all of the time steps.

19. The system according to claim 12 wherein the predefined statistical variance range is within three standard deviations of a mean or trend line of the FLL values for previous files.

20. The system according to claim 12 further comprising the machine, the machine being an industrial robot, where the operations performed by the robot include moving a tool center point along a plurality of different spatial paths and moving the tool center point along a prescribed spatial path with different velocity profiles, and where the one or more parameters include combinations of actual and commanded positions and torques at one or more joints in the robot.
